(19) United States
(12) Patent Application Publication
(10) Pub. No.: US 2025/0231866 A1
(43) Pub. Date: Jul. 17, 2025

(54) WEAR LEVELING SCHEMES BASED ON RANDOMIZED PARAMETERS

(71) Applicant: Micron Technology, Inc., Boise, ID (US)

(72) Inventor: Marco SFORZIN, Cernusco Sul Naviglio (IT)

(21) Appl. No.: 19/000,372

(22) Filed: Dec. 23, 2024

Related U.S. Application Data
(60) Provisional application No. 63/621,510, filed on Jan. 16, 2024.

(51) Int. Cl. G06F 12/02; G06F 21/55

(52) U.S. Cl. CPC G06F 12/023; G06F 21/552; G06F 2221/034

(57) ABSTRACT

In some implementations, a memory device may receive, from a host device, a write command instructing the memory device to write host data to a portion of a memory associated with a logical address. The memory device may determine a physical location of the memory associated with the logical address by using a wear leveling algorithm to map the logical address to the physical location of the memory, wherein the portion of the memory is associated with a wear leveling pool, and wherein the wear leveling algorithm maps the logical address to a portion of the wear leveling pool based on a randomized parameter. The memory device may write the host data to the physical location of the memory.

### CROSS-REFERENCE TO RELATED APPLICATION

This patent application claims priority to U.S. Provisional Patent Application No. 63/621,510, filed on Jan. 16, 2024, entitled “WEAR LEVELING SCHEMES BASED ON RANDOMIZED PARAMETERS,” and assigned to the assignee hereof. The disclosure of the prior application is considered part of and is incorporated by reference into this patent application.

### TECHNICAL FIELD

The present disclosure generally relates to memory devices, memory device operations, and, for example, to wear leveling schemes based on randomized parameters.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of wear leveling schemes based on randomized parameters.

FIG. 2 is a diagram of example components included in a memory device.

FIGS. 3A-3B are diagrams illustrating an example of logical-to-physical mapping.

FIGS. 4A-4G are diagrams of examples associated with wear leveling schemes based on randomized parameters.

FIG. 5 is a flowchart of an example method associated with wear leveling schemes based on randomized parameters.

### DETAILED DESCRIPTION

A memory device may use a wear leveling scheme, such as for a purpose of distributing read/write operations across a portion of a memory (e.g., a wear leveling pool) in order to prolong the life of the memory. Wear leveling may refer to changing, with time, a logical-to-physical (L2P) map of the memory in order to distribute read/write cycles among numerous physical locations of the memory. In such examples, if a hacker or a similar entity attempts to hammer a single memory location, the hammering may be distributed across multiple physical locations, thereby thwarting the attack and/or otherwise prolonging the life of the memory device.

Some wear leveling techniques employ a start-gap algorithm to define an L2P map for the memory, in which the L2P map is defined by two pointers: a start pointer and a gap pointer. A physical location pointed to by the gap pointer may be changed after each wear leveling step event, and a physical location pointed to by the start pointer may be changed after iterations of the gap pointer, such that physical memory locations containing data elements change over time, thereby distributing read/write operations among numerous physical locations of a wear leveling pool. A wear leveling step event may correspond to, for example, a period of time or a number of accesses to the wear leveling pool. The gap pointer may decrease rotationally over the wear leveling pool at each wear leveling step event, and the location of the start pointer may increase rotationally over the wear leveling pool after each round of the gap pointer. Accordingly, if a hacker attempts to hammer a certain logical address, the hammering will be distributed across the wear leveling pool, thereby prolonging the life of the memory device.

However, known wear leveling schemes (e.g., wear leveling schemes employing a start-gap algorithm or feature) may be deterministic and/or may be based on a deterministic wear leveling algorithm. For example, because the start-gap algorithm is based on a deterministic function, a hacker or similar entity may be capable of hammering a single physical location of a memory if the hacker or similar entity is aware of the various parameters associated with the stop-gap algorithm. For example, if a hacker correctly identifies the values of the start pointer, the gap pointer, a period of time corresponding to a wear leveling step event, and/or a quantity of wear leveling pool accesses corresponding to a wear leveling step event, the hacker may mimic the L2P table dynamic, thereby making the wear leveling scheme ineffective and thus resulting in reduced memory life.

Some implementations described herein enable a memory device to employ an unpredictable wear leveling scheme, thereby preventing attacks that may otherwise be successful for deterministic wear leveling schemes. In some examples, a wear leveling scheme and/or a wear leveling algorithm may be based on a randomized parameter, such as a randomized time threshold associated with a wear leveling step event and/or randomized activity threshold associated with the wear leveling step event. More particularly, the randomized time threshold and/or the randomized activity threshold may change at each wear leveling step event in a random and/or unpredictable way, thereby preventing a hacker from hammering a single physical location of the memory device. Accordingly, based on employing a wear leveling scheme associated with a randomized parameter, some implementations described herein may more effectively distribute read/write operations across a memory, thereby increasing a useful life of a memory device, and/or may increase a reliability of host data stored in the memory, thereby reducing power, computing, and other resource consumption otherwise required to correct corrupted data.

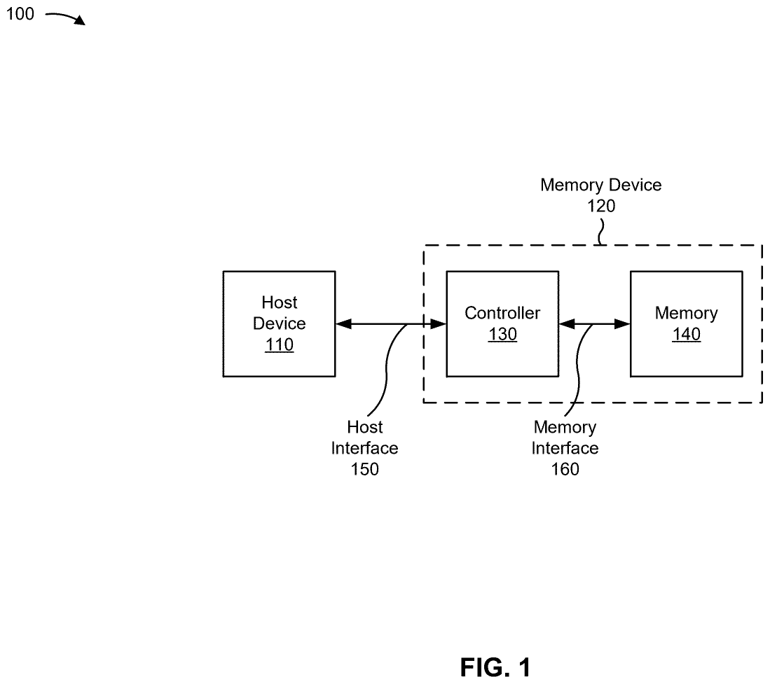

FIG. 1 is a diagram illustrating an example system 100 capable of wear leveling schemes based on randomized parameters. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a graphics processing unit (GPU), a field-programmable gate array (FPGA), an application-specific integrated circuit (ASIC), and/or another type of processing component.

The memory device 120 may be any electronic device configured to store data in memory. In some implementations, the memory device 120 may be an electronic device configured to store data temporarily in volatile memory. For example, the memory device 120 may be a random-access memory (RAM) device, such as a dynamic RAM (DRAM) device or a static RAM (SRAM) device. In this case, the memory 140 may include volatile memory that requires power to maintain stored data and that loses stored data after the memory device 120 is powered off. For example, the memory 140 may include one or more latches and/or RAM, such as DRAM and/or SRAM. In some implementations, the memory 140 may include non-volatile memory configured to maintain stored data after the memory device 120 is powered off, such as NAND memory or NOR memory. For example, the non-volatile memory may store persistent firmware or other instructions for execution by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be a solid-state drive (SSD) controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a universal serial bus (USB) interface, a Universal Flash Storage (UFS) interface, and/or an embedded multimedia card (eMMC) interface.

In some examples, the memory device 120 may be a compute express link (CXL) compliant memory device 120. For example, the memory device 120 may include a PCIe/CXL interface (e.g., the host interface 150 may be associated with a PCIe/CXL interface). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide advanced protocol in areas such as input/output (I/O) protocol, memory protocol, and coherency interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be configured to receive, from a host device, a write command instructing the memory device 120 to write host data to a portion of a memory associated with a logical address; determine a physical location of the memory associated with the logical address by using a wear leveling algorithm to map the logical address to the physical location of the memory, wherein the wear leveling algorithm is based on a randomized parameter; and write the host data to the physical location of the memory.

In some implementations, one or more systems, devices, apparatuses, components, and/or controllers of FIG. 1 may be configured to receive, from a host device, a write command instructing the memory device 120 to write host data to a portion of a memory associated with a logical address; determine a physical location of the memory associated with the logical address by using a wear leveling algorithm to map the logical address to the physical location of the memory, wherein the portion of the memory is associated with a wear leveling pool, and wherein the wear leveling algorithm maps the logical address to a portion of the wear leveling pool based on a randomized parameter; and write the host data to the physical location of the memory.

In some implementations, one or more systems, devices, apparatuses, components, and/or controllers of FIG. 1 may be configured to receive, from a host device, a write command instructing the memory device 120 to write host data to a portion of a memory associated with a logical address; determine a physical location of the memory associated with the logical address by using a wear leveling algorithm to map the logical address to the physical location of the memory, wherein the wear leveling algorithm is associated with one of a periodic wear leveling scheme based on a time threshold or an activity-based wear leveling scheme based on an activity threshold, and wherein the wear leveling algorithm randomizes one of the time threshold or the activity threshold; and write the host data to the physical location of the memory.

As indicated above, FIG. 1 is provided as an example. Other examples may differ from what is described with regard to FIG. 1.

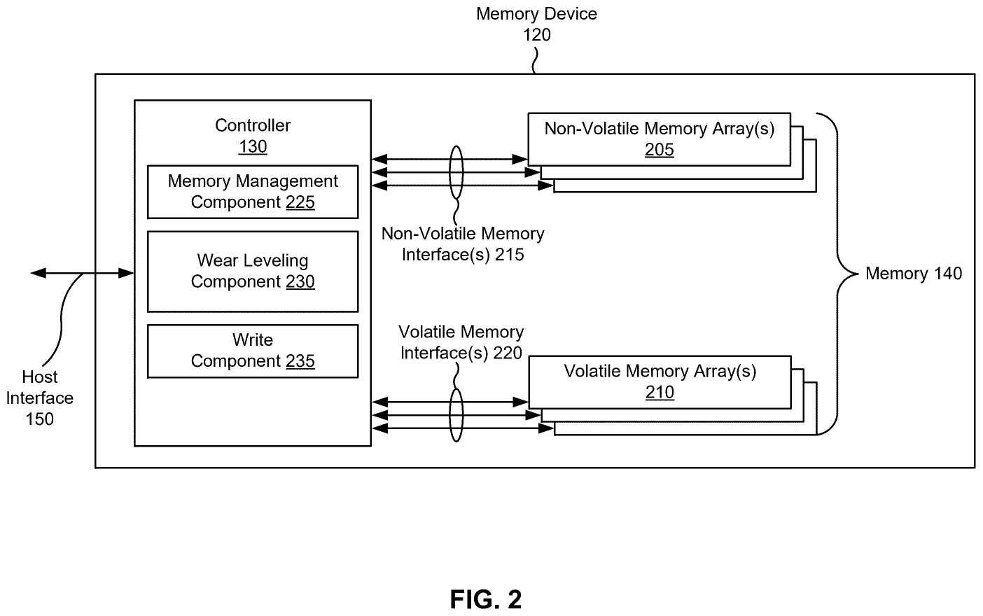

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

As shown in FIG. 2, the controller 130 may include a memory management component 225, a wear leveling component 230, and/or a write component 235. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear leveling, bad block management, block retirement, read disturb management, and/or other memory management operations. In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like).

The wear leveling component 230 may be configured to control wear leveling operations at the memory device 120. In some examples, the wear leveling component 230 may be configured to change, with time, an L2P map of the memory device 120 such that read and/or write operations associated with a given logical address may be distributed over multiple physical locations of the device. In some examples, the wear leveling component 230 may be configured to map a logical address to a physical location of a memory 140 using a wear leveling algorithm, such as a stop-gap algorithm or a similar wear leveling algorithm. Additionally, or alternatively, the wear leveling component 230 may be configured to perform periodic wear leveling schemes, activity-based wear leveling schemes, and/or other types of wear leveling schemes.

The write component 235 may be configured to program, or write, host data to the memory 140. In some implementations, the write component 235 may be configured to write host data to the memory 140 based on an L2P mapping defined by a wear leveling scheme and/or a wear leveling algorithm, such as based on one of a periodic wear leveling scheme, an activity-based wear leveling scheme, and/or a similar wear leveling scheme. The write component 235 may be capable of applying a voltage to a memory cell, such as for a purpose of storing a threshold voltage corresponding to a binary value in the memory cell.

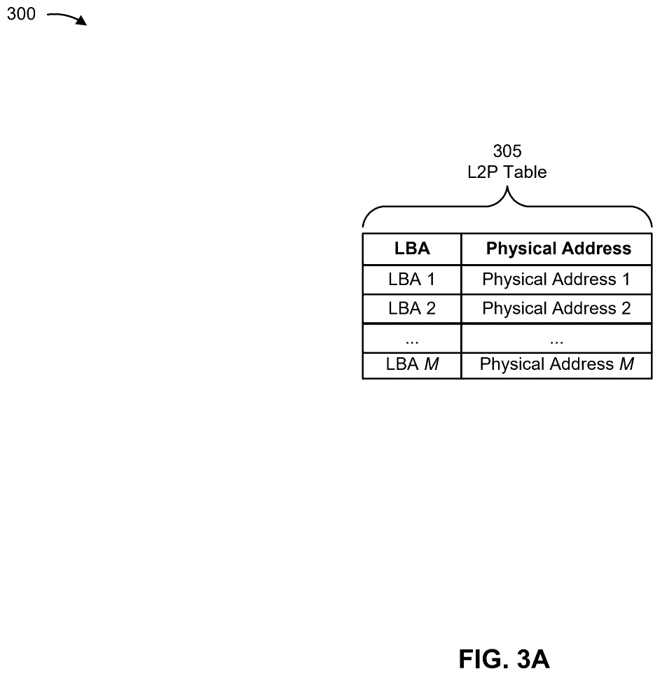

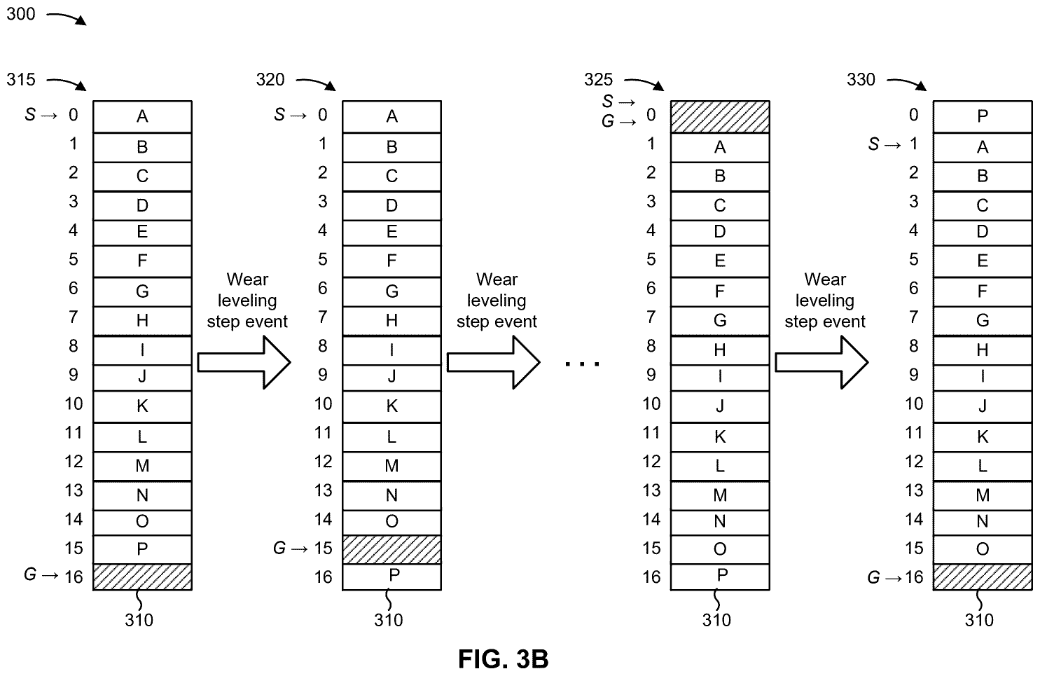

One or more devices or components shown in FIG. 2 may be configured to perform operations described herein, such as one or more operations and/or methods described in connection with FIGS. 3-5. For example, the controller 130, the memory management component 225, the wear leveling component 230, and/or the write component 235 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

FIGS. 3A-3B are diagrams illustrating an example 300 of L2P mapping. For example, FIG. 3A depicts an example of memory address translation using an L2P table 305, and FIG. 3B depicts a wear leveling scheme used to define values of an L2P table, such as the L2P table 305, such as at each wear leveling step event of a wear leveling scheme.

As shown in FIG. 3A, a memory system may store one or more address translation tables. An address translation table may be referred to as an L2P mapping table, an L2P address table, or an L2P table, and may be used to translate a logical memory address to a physical memory address. For example, the memory system may receive a command (e.g., from a host device 110), and the command may indicate a logical memory address, such as a logical block address (LBA), which is sometimes called a host address. The memory system may use one or more address translation tables to identify a physical memory address (sometimes called a physical address) corresponding to the logical memory address. For example, a read command may indicate an LBA from which data is to be read, or a write command may indicate an LBA to which data is to be written (or to overwrite data previously written to that LBA). The memory system may translate that LBA (or multiple LBAs) to a physical address associated with the memory system (e.g., a physical address in a memory array) using an L2P table (or multiple L2P tables). The physical address may indicate a physical location in memory, such as a die, a plane, a block, a page, and/or a portion of the page where the data is located.

In some implementations, the memory system may use a logical address called a translation unit (TU), which may correspond to one or more LBAs. For example, an entry in an L2P table may indicate a mapping between a TU (e.g., indicated by a TU index value) and a physical address where data associated with that TU is stored. In some implementations, the physical address may indicate a die, a plane, a block, and a page of the TU. In other examples, the physical address may indicate a die, a plane, a block, and/or a page where data associated with an LBA is written or programmed to.

The memory system may use an L2P table 305 for performing L2P address translations. For example, the L2P table 305 may map logical addresses (e.g., LBAs) to physical addresses in a non-volatile memory of the memory system (e.g., physical addresses in one or more memory arrays of the memory system). Although an LBA is described herein as an example of a logical address included in the L2P table 305, other logical addresses or logical units, such as a TU, or a set of LBAs, among other examples, may be used in a similar manner as described herein. In some implementations, the L2P table 305 may be an entire L2P table. In other implementations, the L2P table 305 may be a portion of an L2P table (e.g., a set of entries of the L2P table and/or an address range associated with the L2P table), and/or a physical page table (PPT) associated with an L2P table, among other examples. For example, the L2P table 305 may include a set of LBA and physical address pairs (e.g., a pair may include an LBA and the corresponding physical address, associated with the LBA, in non-volatile memory).

In some examples, a memory device 120 may use the L2P table 305 or a similar L2P mapping as part of a wear leveling scheme. A wear leveling scheme may be associated with techniques adopted to prolong the life of a memory device 120, such as a memory device 120 associated with a memory technology that has a limited endurance. In some examples, an endurance of a memory device 120 may be expressed in terms of a maximum quantity of read/write cycles the memory device 120 is capable of sustaining before failing. Accordingly, if traffic of an application is addressed on a single memory location, and the quantity of read/write cycles contained in the traffic exceeds the maximum quantity of read/write cycles sustainable by the memory device 120, then the application may cause the memory device 120 to fail. For example, a hacker attempting to break a memory device 120 may hammer a physical memory location with numerous read/write commands in order to exceed the maximum quantity of read/write cycles sustainable by the memory device 120, thereby causing the memory device 120 to fail.

In some examples, a memory device 120 may use wear leveling techniques in order to distribute read/write operations across numerous physical memory locations, thereby prolonging the life of the memory device 120. Wear leveling may refer to changing, with time, an L2P map (e.g., L2P table 305) of a memory device 120 in order to distribute read/write cycles among numerous physical locations of the memory device 120. In such examples, if a hacker or a similar entity attempts to hammer a single memory location, the hammering may be distributed across multiple physical locations, thereby thwarting the attack and/or otherwise prolonging the life of the memory device 120.

As shown in FIG. 3B, in some wear leveling techniques, a memory device 120 may use a start-gap algorithm to define an L2P map for the memory device. For start-gap-algorithm-based examples, the L2P map may be defined by two pointers: a start pointer (shown in FIG. 3B as S) and a gap pointer (shown in FIG. 3B as G). A memory device 120 may use the start-gap algorithm to map a logical address to a physical location of a wear leveling pool 310 of a memory 140. In the example shown in FIG. 3B, the wear leveling pool 310 may include a set of seventeen physical memory locations, indexed 0-16, for maintaining a set of sixteen data elements, shown as data elements A through P. As indicated by reference number 315, at the beginning of the operation of the start-gap algorithm, the data elements A-P may be stored in consecutive memory locations of the wear leveling pool 310, starting from memory location 0, which is designated the “start” location, and extending through memory location 15. Memory location 16 may be unused and/or may be designated as the “gap” location. In such examples, the start pointer (e.g., S) may point to the first memory location (e.g., memory location 0), and the gap pointer (e.g., G) may point to a location that has no data stored in it (e.g., memory location 16) and/or that is skipped over during read/write procedures. Thus, at a first iteration, memory locations 0-15 may include data elements A-P, while location 16 may be unused (shown using cross-hatching in FIG. 3B).

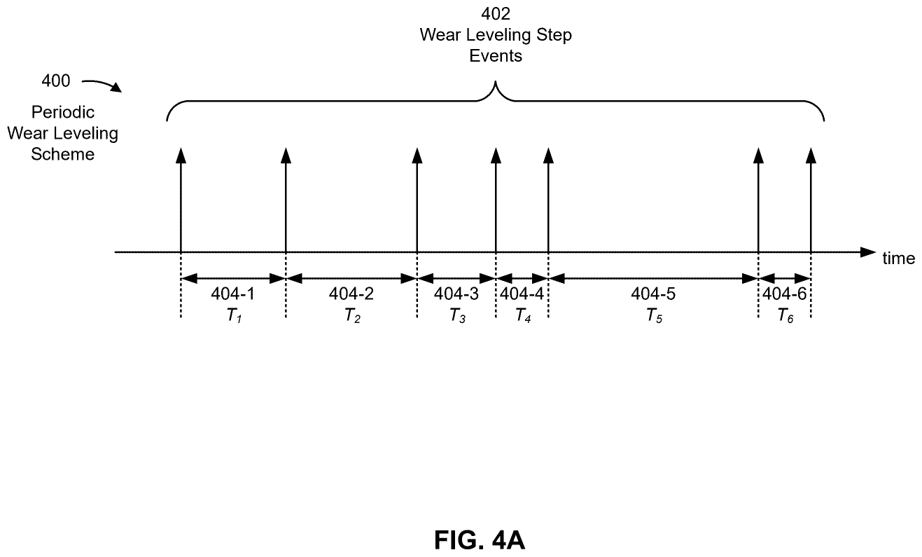

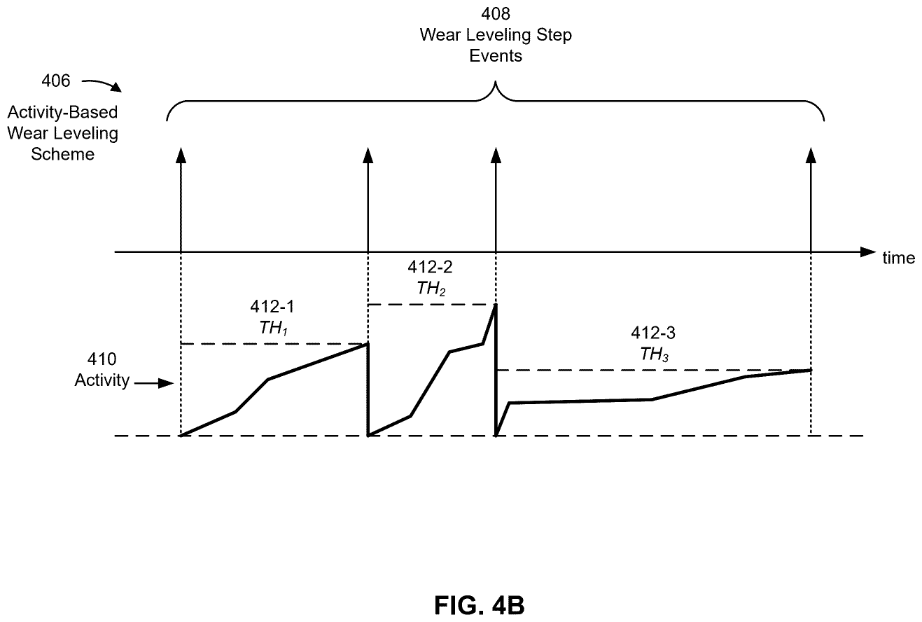

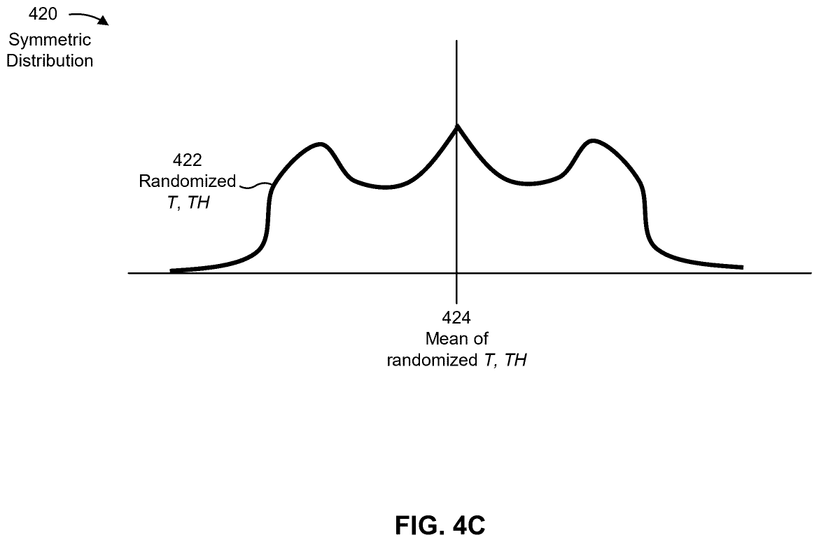

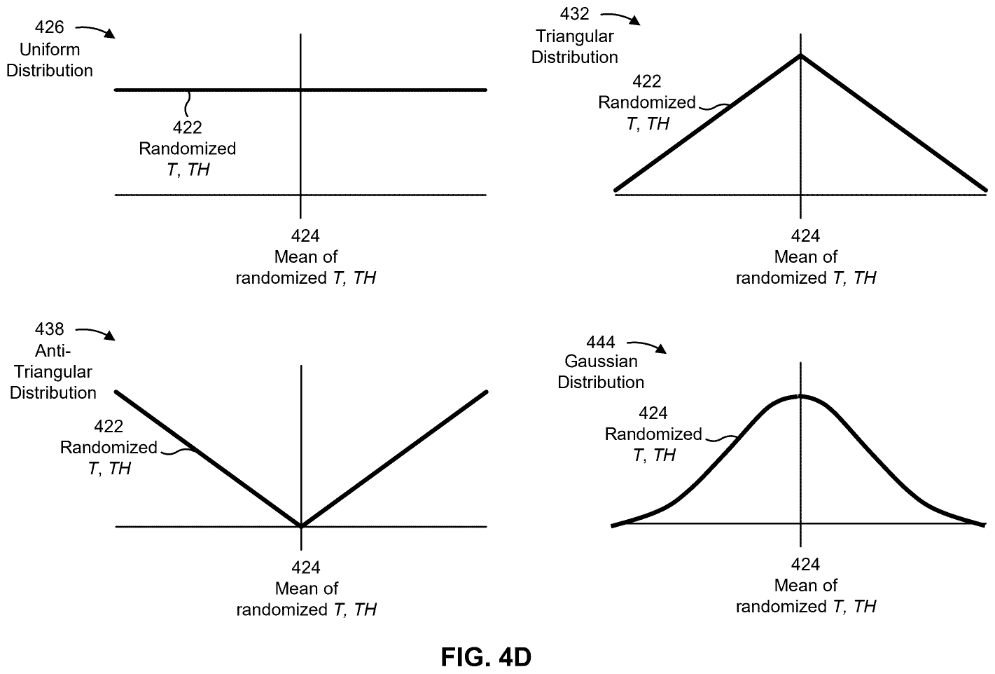

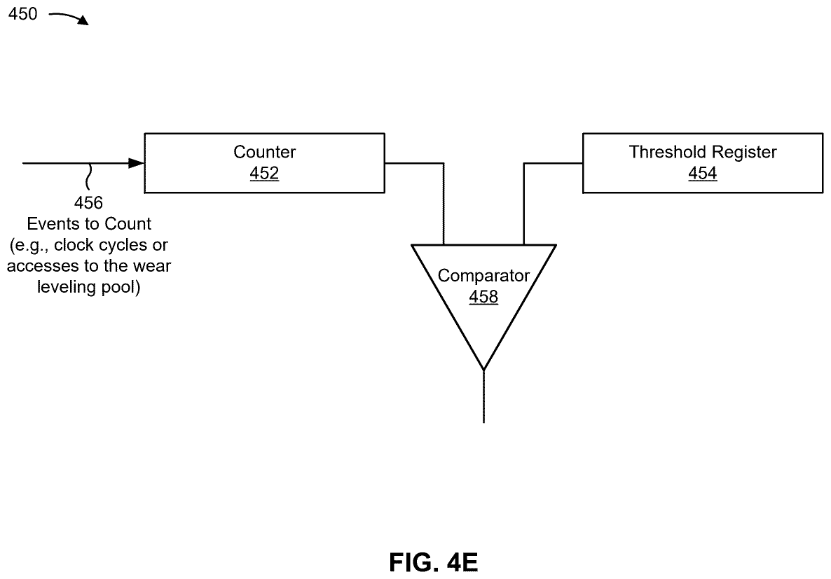

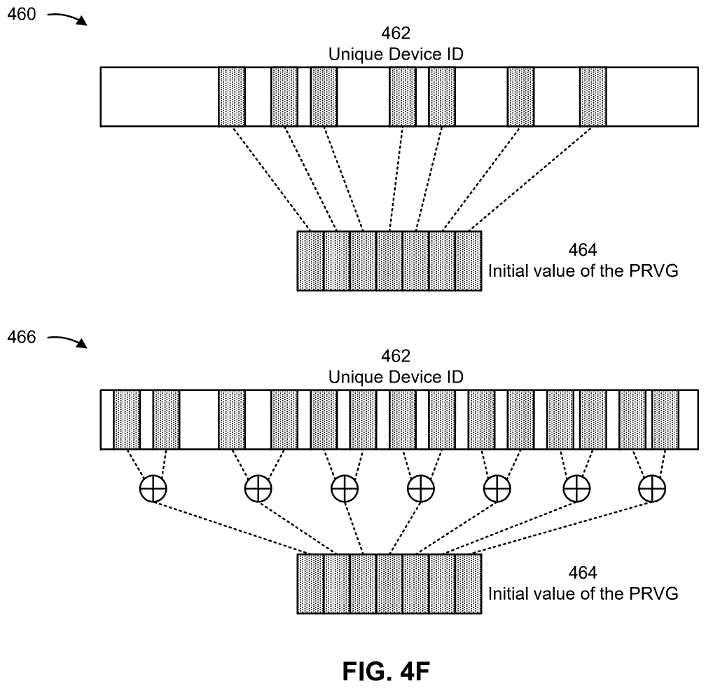

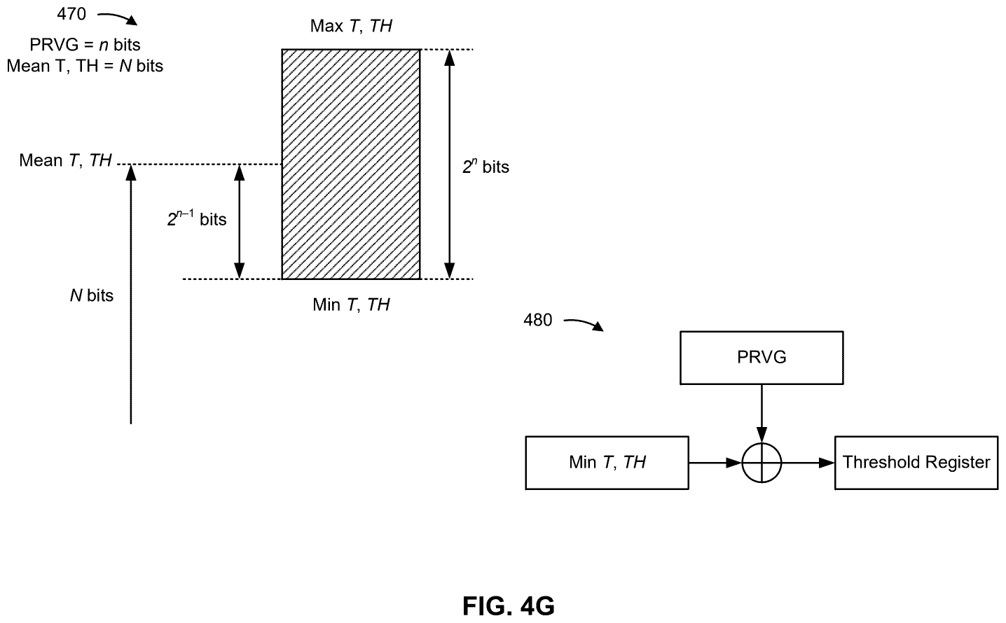

The location of the start pointer and/or the gap pointer may be changed after each wear leveling step event associated with the wear leveling algorithm, such that the memory locations containing data elements and/or the location left unused (e.g., the location associated with the gap pointer) change over time, thereby distributing read/write operations among numerous physical locations of the wear leveling pool 310. A wear leveling step event may correspond to, for example, a period of time (e.g., for periodic wear leveling schemes), or a number of accesses to the wear leveling pool 310 (e.g., for activity-based wear leveling schemes), among other examples. Aspects of periodic wear leveling schemes and activity-based wear leveling schemes are described in more detail below in connection with FIGS. 4A and 4B. In such examples, the gap pointer (e.g., G) may decrease rotationally over the wear leveling pool 310 at each wear leveling step event, and the location of the start pointer may increase rotationally over the wear leveling pool 310 after each round of the gap pointer (e.g., after the gap pointer has rotated to each memory location of the wear leveling pool 310).

More particularly, as indicated by reference number 320, after a first wear leveling step event, the gap pointer may rotate to memory location 15, and thus data elements A-O may be stored in locations memory locations 0-14, respectively, and data element P may be stored in memory location 16, with memory location 15 being left unused at the new gap location. In this regard, prior to decreasing the memory location of the gap pointer (e.g., G), data in the memory location G-1 is copied into the memory location associated with G. More particularly, in the example shown in FIG. 3B, prior to moving the gap pointer to memory location 15 (e.g., G-1), the data in memory location 15 is copied and moved to memory location 16. Over time the gap location travels or rotates to successively lower addresses between iterations.

As indicated by reference number 325, after multiple (e.g., sixteen) wear leveling step events, the gap location will rotate all the way to memory location 0, and memory locations 1 through 16 may thus be used to store data elements A-P with memory location 0 remaining unused. As shown by reference number 330, at the next iteration of the start-gap algorithm, the gap location wraps around to memory location 16, and the start location increments by one to memory location 1 (e.g., the location of the gap pointer decreases rotationally over the wear leveling pool 310 at each wear leveling step event and the location of the start pointer increases rotationally over the wear leveling pool 310 after each round of the gap pointer). In this regard, data elements may be stored in the memory locations 0-15, with data element A now being stored at memory location 1 (e.g., the location of the start pointer) and data element P being stored at memory location 0, with memory location 16 (e.g., the location associated with the gap pointer) remaining unused. In this regard, over time (e.g., over multiple wear leveling step events) the data elements A-P may be rotated through all different memory locations of the wear leveling pool 310 so that frequently written and/or read data elements are rotated through all the memory locations and/or such that the memory is effectively wear leveled. For example, if a memory device 120 becomes under attack by a hacker with a certain logical address being hammered by the hacker, the hammering may be distributed across the wear leveling pool 310 (e.g., across the memory locations 0-16 in the example described above), thereby distributing the read/write accesses across the memory 140 and thus prolonging the life of the memory 140.

However, because the start-gap algorithm is based on a deterministic function, a hacker or a similar entity may be capable of hammering a single physical location of a memory 140 if the hacker or similar entity is aware of the various parameters associated with the stop-gap algorithm. For example, if a hacker correctly identifies the values of S, G, and/or a period of time corresponding to a wear leveling step event for periodic wear leveling schemes or a quantity of wear leveling pool accesses corresponding to a wear leveling step event for activity-based wear leveling schemes, the hacker may mimic the L2P table dynamic in order to hammer a specific physical location, thereby making the wear leveling scheme ineffective and thus resulting in reduced memory life and/or unreliable data storage.

Some techniques and apparatuses described herein enable a memory device 120 to employ an unpredictable wear leveling scheme, thereby preventing attacks that may otherwise be successful for deterministic wear leveling schemes. In some examples, a wear leveling scheme and/or a wear leveling algorithm may be based on a randomized parameter, such as a randomized time threshold for a periodic wear leveling scheme and/or a randomized activity threshold for an activity-based wear leveling scheme, in order to render the wear leveling scheme unpredictable to a hacker or a similar entity. Implementations associated with wear leveling schemes that implement randomized parameters are described in more detail below in connection with FIGS. 4A-4G.

As indicated above, FIGS. 3A-3B are provided as an example. Other examples may differ from what is described with regard to FIGS. 3A-3B.

FIGS. 4A-4G are diagrams of examples associated with wear leveling schemes based on randomized parameters. The operations described in connection with FIGS. 4A-4G may be performed by the memory device 120 and/or one or more components of the memory device 120, such as the controller 130 and/or one or more components of the controller 130.

In some implementations, a memory device 120 may receive a write command from a host device 110 that instructs the memory device 120 to write host data to a portion of a memory 140 associated with a logical address. In such implementations, the memory device 120 may map the logical address to a physical location of the memory, such as by using an L2P table (e.g., L2P table 305) or a similar mapping technique. To do so, the memory device 120 may utilize a wear leveling scheme and/or a wear leveling algorithm to identify the physical location for writing the host data, such as for a purpose of distributing read/write commands across the memory 140 (e.g., across a wear leveling pool 310 of the memory 140). In some implementations, rather than determining a physical location using a deterministic function, such as described above in connection with the example of FIG. 3B, the memory device 120 may map the logical address to a physical location of the memory 140 based on a randomized parameter. Put another way, the memory device 120 may determine a physical location of the memory 140 associated with the logical address by using a wear leveling algorithm to map the logical address to the physical location of the memory 140, with the wear leveling algorithm in turn being based on a randomized parameter (e.g., a randomized time threshold and/or a randomized activity threshold, which is described in more detail below). In this regard, the memory device 120 may be configured to distribute read/write commands across physical locations of the memory 140 (e.g., across a wear leveling pool 310 of the memory 140) in a random and/or unpredictable manner, thereby rendering deterministic attacks ineffective and thus increasing the useful life cycle of the memory device 120.

In some implementations, the wear leveling algorithm may be based on a periodic wear leveling scheme, such as the periodic wear leveling scheme shown by reference number 400 in FIG. 4A. As indicated by reference number 402, the periodic wear leveling scheme may be associated with a number of wear leveling step events, which may be associated with movement of a start pointer and/or gap pointer, as described above in connection with FIG. 3B. In such implementations, the memory device 120 may be configured to move a gap pointer after each wear leveling step event and/or the memory device 120 may be configured to move a start pointer after each round of the gap pointer (e.g., after the gap pointer has rotated through every memory location associated with a wear leveling pool), with the wear leveling step event being associated with a time threshold (sometimes referred to herein as T). In such implementations, the memory device 120 may determine whether a period of time that has elapsed since a previous wear leveling step event satisfies the time threshold (e.g., T), and, if so, may perform a step of a wear leveling algorithm, such as moving the gap pointer (e.g., G) as described above in connection with FIG. 3B. For example, the time threshold may be associated with a number of clock cycles, and thus the memory device 120 may count a quantity of clock cycles that have occurred since a last wear leveling step event and compare the count to the time threshold (e.g., T) to determine if a wear leveling step event is to take place, which is described in more detail below in connection with FIG. 4E.

As further shown in FIG. 4A, the time threshold (e.g., T) may vary randomly and/or unpredictably for each respective wear leveling step event, such that the wear leveling step events occur at randomized intervals and/or in an unpredictable manner. For example, a first time threshold, shown in FIG. 4A as Ty and as indicated by reference number 404-1, may be different than a second time threshold (e.g., T2, indicated by reference number 404-2), which may in turn be different than a third time threshold (e.g., T3, indicated by reference number 404-3), and so forth up through the sixth time threshold (e.g., T6, indicated by reference number 404-6) in the example shown in FIG. 4A. In this way, for implementations in which the wear leveling algorithm is associated with a periodic wear leveling scheme in which a corresponding wear leveling step event is performed after a time threshold is satisfied (e.g., after a number of clock cycles have passed), the time threshold may be randomized at each wear leveling step event.

As shown in FIG. 4B, and as indicated by reference number 406, in some implementations the wear leveling algorithm may correspond to an activity-based wear leveling scheme. As indicated by reference number 408, the activity-based wear leveling scheme may be associated with a number of wear leveling step events, which may be associated with movement of a start pointer and/or gap pointer, as described above in connection with FIG. 3B. In such implementations, each wear leveling step event may be associated with an activity threshold (sometimes referred to as TH). In such implementations, the memory device 120 may determine whether an amount of activity that has taken place since a previous wear leveling step event satisfies the activity threshold (e.g., TH), and, if so, the memory device 120 may perform a step of a wear leveling algorithm, such as moving the gap pointer (e.g., G) described above in connection with FIG. 3B. In some implementations, the activity threshold (e.g., TH) may be associated with a quantity of read/write operations associated with a wear leveling pool, a quantity of accesses to the wear leveling pool, or the like, and thus the memory device 120 may count a quantity of read/write operations associated with the wear leveling pool, a quantity of accesses to the wear leveling pool, or the like, and compare the count to the activity threshold (e.g., TH) to determine if a wear leveling step event is to take place, which is described in more detail below in connection with FIG. 4E.

As shown by the plot indicated by reference number 410, an activity level associated with a wear leveling pool may vary over time, with periods of high activity being associated with a relatively steep slope in the plot shown in connection with reference number 410, and with periods of low activity being associated with a relatively shallow slope in the plot shown in connection with reference number 410. When a cumulative activity level for a given wear leveling step event reaches the activity threshold (e.g., TH), the memory device 120 may perform a procedure associated with a wear leveling algorithm, such as moving the gap pointer (e.g., G) associated with a start-gap algorithm. As shown in FIG. 4B, the activity threshold (e.g., TH) may vary randomly and/or unpredictably for each respective wear leveling step event, such that the wear leveling step events occur at randomized intervals and/or in an unpredictable manner. For example, a first activity threshold, shown in FIG. 4B as TH₁ and as indicated by reference number 412-1, may be different than a second activity threshold, shown as TH₂ and indicated by reference number 412-2, which may in turn be different than a third time threshold, shown as TH₃ and indicated by reference number 412-3. In this way, for implementations in which the wear leveling algorithm is associated with an activity-based wear leveling scheme in which a corresponding wear leveling step event is performed after an activity threshold is satisfied, the activity threshold may be randomized at each wear leveling step event.

In implementations in which a time threshold associated with a periodic wear leveling scheme is randomized as described above in connection with FIG. 4A and/or in implementations in which an activity threshold associated with an activity-based wear leveling scheme is randomized as described above in connection with FIG. 4B, a dynamic of the wear leveling scheme may be unpredictable, thereby increasing the robustness of the wear leveling scheme in the face of an attempted attack. In this way, the memory device 120, upon receiving (e.g., from a host device 110) a write command instructing the memory device to write host data to a portion of a memory associated with a logical address, may determine a physical location of the memory associated with the logical address by using a wear leveling algorithm to map the logical address to the physical location of the memory, with the wear leveling algorithm being based on a randomized parameter (e.g., a randomized T and/or TH), and thus may write the host data to the physical location of the memory determined using the randomized parameter.

In some implementations, the randomized parameter may be symmetrically distributed about a mean value, such as for a purpose of preserving the effectiveness of the wear leveling scheme as compared to schemes in which a constant parameter (e.g., a constant T or TH) is employed. For example, in some implementations, the wear leveling algorithm may be associated with multiple wear leveling step events (e.g., the multiple wear leveling step events shown in connection with reference number 402 in FIG. 4A and/or the multiple wear leveling step events shown in connection with reference number 408 in FIG. 4B) and multiple instances of the randomized parameter (e.g., the multiple T values shown in connection with reference number 404 in FIG. 4A and/or the multiple TH values shown in connection with reference number 412 in FIG. 4B), with each wear leveling step event being associated with a corresponding instance of the randomized parameter. In such implementations, and as shown by reference number 420 in FIG. 4C, the multiple instances of the randomized parameter (indicated by reference number 422) may be symmetrically distributed about a mean value of the multiple instances of the randomized parameter (indicated by reference number 424). In some implementations, the mean value of the multiple instances of the randomized parameter (e.g., the multiple instances of T and/or TH) may correspond to the constant value of traditional wear leveling schemes (e.g., the value of T when Tis held constant for each wear leveling step event of traditional wear leveling schemes and/or the value of TH when TH is held constant for each wear leveling step event of traditional wear leveling schemes).

In some implementations, the randomized parameter (e.g., T and/or TH) may be symmetrically distributed about the mean value of the randomized parameter based on a particular distribution scheme. For example, as shown in FIG. 4D, and as indicated by reference number 426, in some implementations the randomized parameter may be symmetrically distributed about the mean value based on a uniform distribution. In some other implementations, as indicated by reference number 432, the randomized parameter may be symmetrically distributed about the mean value based on a triangular distribution. In some other implementations, as indicated by reference number 438, the randomized parameter may be symmetrically distributed about the mean value based on an anti-triangular distribution. And in still some other implementations, as indicated by reference number 444, the randomized parameter may be symmetrically distributed about the mean value based on a Gaussian distribution.

As shown in FIG. 4E, and as indicated by reference number 450, in some implementations a memory device 120 may be configured to determine whether to move from one wear leveling step event of a wear leveling algorithm to a next wear leveling step event of the wear leveling algorithm by comparing a counter 452 to a corresponding value of a randomized parameter (e.g., the one of the randomized T or the randomized TH) for the current wear leveling step event. More particularly, at each wear leveling step event, the memory device 120 may redefine the randomized parameter and/or store a new value of the randomized parameter in a register (e.g., a threshold register 454, as shown in FIG. 4E) and/or the memory device 120 may reset the counter 452 to zero. Accordingly, as indicated by reference number 456, the counter 452 may be increased as events to count occur at the wear leveling pool. For example, in periodic wear leveling schemes, the events to count may be clock cycles associated with the memory device 120, and for activity-based wear leveling schemes, the events to count may be accesses to the wear leveling pool (e.g., read/write operations associated with the wear leveling pool). Put another way, the counter 452 may be associated with one of a quantity of clock cycles associated with a corresponding wear leveling step event or a quantity of accesses to the portion of the memory (e.g., a wear leveling pool) associated with the corresponding wear leveling step event.

Using a comparator 458 or a similar component, the memory device 120 may compare the counter 452 to the threshold register 454 to see if the randomized threshold (e.g., one of T or TH) is satisfied for the corresponding wear leveling step event. If so, the memory device may perform an operation associated with the wear leveling algorithm (e.g., move the gap pointer, G, and/or the start pointer, S, among other examples), may reset the counter 452, and/or may generate a new randomized parameter (e.g., a new T and/or TH) and store the new randomized parameter in the threshold register 454. Aspects associated with generating the new randomized parameter are described in more detail below in connection with FIGS. 4F and 4G. The memory device 120 may then proceed in a like manner as described above for the next wear leveling step event by counting events (e.g., clock cycles or accesses to the wear leveling pool) and comparing the counter 452 to the new randomized parameter.

As shown in FIG. 4F, in some implementations a memory device 120 may be configured to determine the randomized parameter by using a pseudo-random vector generator (PRVG), such as a PRVG that is based on an identifier (ID) associated with the memory device 120 (e.g., a unique device ID of the memory device 120). For example, as indicated by reference number 460, in some implementations an initial value of the PRVG 464 (sometimes referred to as a seed of the PRVG) may be derived from a unique device ID 462 of the memory device 120, such as by using a concatenation of finite fields and/or Galois fields associated with the unique device ID 462 as the initial value of the PRVG 464. In such implementations, the next content of the PRVG (e.g., a value of the PRVG for a subsequent wear leveling step event) may then be obtained by the memory device 120 triggering an update of the PRVG. In some other implementations, the initial value of the PRVG 464 may be determined using some function that is based on the unique device ID 462. For example, in the implementation shown by reference number 466, the initial value of the PRVG 464 may be derived by adding certain values and/or fields of the unique device ID 462 and concatenating the results to arrive the initial value of the PRVG 464.

FIG. 4G shows an example of how a PRVG may be used to determine a randomized parameter for a wear leveling scheme, such as a randomized time threshold (e.g., T) for a periodic wear leveling scheme and/or an activity threshold (e.g., TH) for an activity-based wear leveling scheme. In some implementations, and as indicated by reference number 470, a PRVG may be capable of generating a value associated with n bits, which may be used to determine a randomized parameter for which a mean value is associated with N bits. In such implementations, and as indicated by reference number 480, the memory device 120 may determine the randomized parameter at each wear leveling step event by adding a value generated by the PRVG to a minimum value associated with the randomized parameter (e.g., to a minimum value of T or TH), such that resulting randomized parameter falls between the minimum value associated with the randomized parameter (e.g., when a result of the PRVG is zero) and a maximum value associated with the randomized parameter (e.g., a value equal to the minimum value of the randomized parameter plus 2ⁿ). Put another way, in implementations in which the PRVG generates a value having n bits and the mean value of the randomized parameter (e.g., a mean value of T and/or TH) has N bits, the randomized parameter may be determined at each wear leveling step event by adding the value generated by the PRVG to the mean value of the randomized parameter reduced by 2ⁿ⁻¹ (e.g., 111 . . . 1, with the quantity of 1s being equal to n−1).

As indicated above, FIGS. 4A-4G are provided as examples. Other examples may differ from what is described with regard to FIGS. 4A-4G.

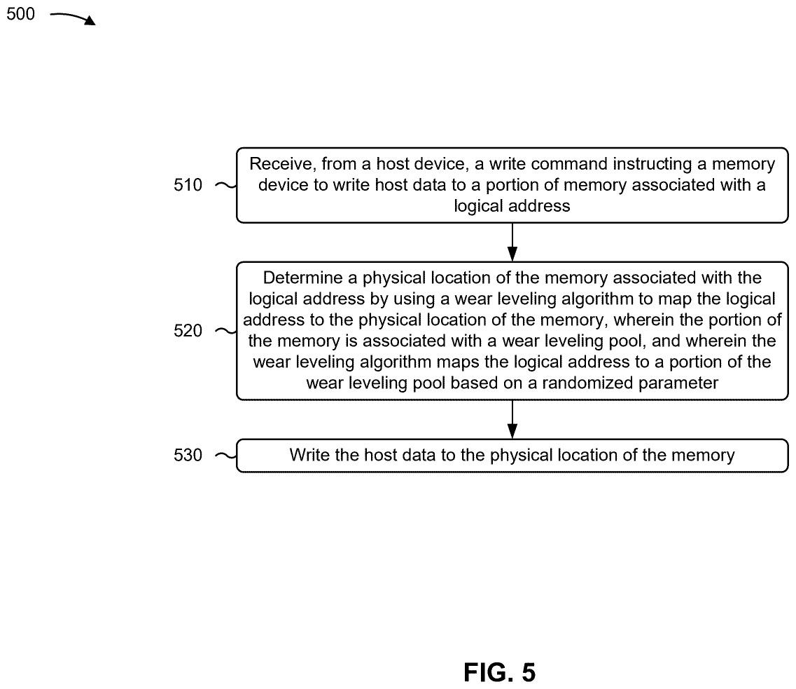

FIG. 5 is a flowchart of an example method 500 associated with wear leveling schemes based on randomized parameters. In some implementations, a memory device (e.g., the memory device 120) may perform or may be configured to perform the method 500. In some implementations, another device or a group of devices separate from or including the memory device (e.g., the system 100) may perform or may be configured to perform the method 500. Additionally, or alternatively, one or more components of the memory device (e.g., the controller 130, the memory management component 225, the wear leveling component 230, and/or the write component 235) may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 500.

As shown in FIG. 5, the method 500 may include receiving, from a host device, a write command instructing the memory device to write host data to a portion of a memory associated with a logical address (block 510). For example, the controller 130 and/or the write component 235 may receive, from a host device, a write command instructing the memory device to write host data to a portion of a memory associated with a logical address. As further shown in FIG. 5, the method 500 may include determining a physical location of the memory associated with the logical address by using a wear leveling algorithm to map the logical address to the physical location of the memory, wherein the portion of the memory is associated with a wear leveling pool, and wherein the wear leveling algorithm maps the logical address to a portion of the wear leveling pool based on a randomized parameter (block 520). For example, the controller 130 and/or the wear leveling component 230 may determine a physical location of the memory associated with the logical address by using a wear leveling algorithm to map the logical address to the physical location of the memory. As further shown in FIG. 5, the method 500 may include writing the host data to the physical location of the memory (block 530). For example, the controller 130 and/or the writ component 235 may write the host data to the physical location of the memory.

The method 500 may include additional aspects, such as any single aspect or any combination of aspects described below and/or described in connection with one or more other methods or operations described elsewhere herein.

In a first aspect, the wear leveling algorithm is associated with a periodic wear leveling scheme, the periodic wear leveling scheme is associated with a wear leveling step event performed after a time threshold is satisfied, and the randomized parameter is the time threshold.

In a second aspect, alone or in combination with the first aspect, the wear leveling algorithm is associated with an activity-based wear leveling scheme, the activity-based wear leveling scheme is associated with a wear leveling step event performed after an activity threshold is satisfied, and the randomized parameter is the activity threshold.

In a third aspect, alone or in combination with one or more of the first and second aspects, the wear leveling algorithm is associated with multiple wear leveling step events and multiple instances of the randomized parameter, with each wear leveling step event, of the multiple wear leveling step events, being associated with a corresponding instance of the randomized parameter, of the multiple instances of the randomized parameter, and the multiple instances of the randomized parameter are symmetrically distributed about a mean value of the multiple instances of the randomized parameter.

In a fourth aspect, alone or in combination with one or more of the first through third aspects, the multiple instances of the randomized parameter are symmetrically distributed about the mean value of the multiple instances of the randomized parameter based on one of a uniform distribution, a triangular distribution, an anti-triangular distribution, or a Gaussian distribution.

In a fifth aspect, alone or in combination with one or more of the first through fourth aspects, the wear leveling algorithm is associated with multiple wear leveling step events, and the method 500 includes determining whether to move from a first wear leveling step event, of the multiple wear leveling step events, to a second wear leveling step event, of the multiple wear leveling step events, by comparing a counter to the randomized parameter. For example, the controller 130 and/or the wear leveling component 230 may determine whether to move from a first wear leveling step event, of the multiple wear leveling step events, to a second wear leveling step event, of the multiple wear leveling step events, by comparing a counter to the randomized parameter.

In a sixth aspect, alone or in combination with one or more of the first through fifth aspects, the counter is associated with one of a quantity of clock cycles associated with a wear leveling step event, of the multiple wear leveling step events, or a quantity of accesses to the portion of the memory associated with the wear leveling step event.

In a seventh aspect, alone or in combination with one or more of the first through sixth aspects, the method 500 includes determining the randomized parameter by using a pseudo-random vector generator that is based on an identifier associated with the memory device. For example, the controller 130 and/or the wear leveling component 230 may determine the randomized parameter by using a pseudo-random vector generator that is based on an identifier associated with the memory device.

In an eighth aspect, alone or in combination with one or more of the first through seventh aspects, determining the randomized parameter by using the pseudo-random vector generator comprises determining the randomized parameter based on adding a value generated by the pseudo-random vector generator to a minimum value associated with the randomized parameter.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory device includes one or more components configured to: receive, from a host device, a write command instructing the memory device to write host data to a portion of a memory associated with a logical address; determine a physical location of the memory associated with the logical address by using a wear leveling algorithm to map the logical address to the physical location of the memory, wherein the wear leveling algorithm is based on a randomized parameter; and write the host data to the physical location of the memory.

In some implementations, a method includes receiving, by a memory device and from a host device, a write command instructing the memory device to write host data to a portion of a memory associated with a logical address; determining, by the memory device, a physical location of the memory associated with the logical address by using a wear leveling algorithm to map the logical address to the physical location of the memory, wherein the portion of the memory is associated with a wear leveling pool, and wherein the wear leveling algorithm maps the logical address to a portion of the wear leveling pool based on a randomized parameter; and writing, by the memory device, the host data to the physical location of the memory.

In some implementations, a non-transitory computer-readable medium storing a set of instructions includes one or more instructions that, when executed by one or more processors of a memory device, cause the memory device to: receive, from a host device, a write command instructing the memory device to write host data to a portion of a memory associated with a logical address; determine a physical location of the memory associated with the logical address by using a wear leveling algorithm to map the logical address to the physical location of the memory, wherein the wear leveling algorithm is associated with one of a periodic wear leveling scheme based on a time threshold or an activity-based wear leveling scheme based on an activity threshold, and wherein the wear leveling algorithm randomizes one of the time threshold or the activity threshold; and write the host data to the physical location of the memory.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host device, a write command instructing the memory device to write host data to a portion of a memory associated with a logical address;
determine a physical location of the memory associated with the logical address by using a wear leveling algorithm to map the logical address to the physical location of the memory, wherein the wear leveling algorithm is based on a randomized parameter; and
write the host data to the physical location of the memory.

2. The memory device of claim 1, wherein the wear leveling algorithm is associated with a periodic wear leveling scheme,
wherein the periodic wear leveling scheme is associated with a wear leveling step event performed after a time threshold is satisfied, and
wherein the randomized parameter is the time threshold.

3. The memory device of claim 1, wherein the wear leveling algorithm is associated with an activity-based wear leveling scheme,
wherein the activity-based wear leveling scheme is associated with a wear leveling step event performed after an activity threshold is satisfied, and
wherein the randomized parameter is the activity threshold.

4. The memory device of claim 1, wherein the wear leveling algorithm is associated with multiple wear leveling step events and multiple instances of the randomized parameter, with each wear leveling step event, of the multiple wear leveling step events, being associated with a corresponding instance of the randomized parameter, of the multiple instances of the randomized parameter, and
wherein the multiple instances of the randomized parameter are symmetrically distributed about a mean value of the multiple instances of the randomized parameter.

5. The memory device of claim 4, wherein the multiple instances of the randomized parameter are symmetrically distributed about the mean value of the multiple instances of the randomized parameter based on one of:
a uniform distribution,
a triangular distribution,
an anti-triangular distribution, or
a Gaussian distribution.

6. The memory device of claim 1, wherein the wear leveling algorithm is associated with multiple wear leveling step events, and
wherein the one or more components are further configured to determine whether to move from a first wear leveling step event, of the multiple wear leveling step events, to a second wear leveling step event, of the multiple wear leveling step events, by comparing a counter to the randomized parameter.

7. The memory device of claim 6, wherein the counter is associated with one of a quantity of clock cycles associated with a wear leveling step event, of the multiple wear leveling step events, or a quantity of accesses to the portion of the memory associated with the wear leveling step event.

8. The memory device of claim 1, wherein the one or more components are further configured to determine the randomized parameter by using a pseudo-random vector generator that is based on an identifier associated with the memory device.

9. The memory device of claim 8, wherein the one or more components, to determine the randomized parameter by using the pseudo-random vector generator, are configured to determine the randomized parameter based on adding a value generated by the pseudo-random vector generator to a minimum value associated with the randomized parameter.

10. A method, comprising:
receiving, by a memory device and from a host device, a write command instructing the memory device to write host data to a portion of a memory associated with a logical address;
determining, by the memory device, a physical location of the memory associated with the logical address by using a wear leveling algorithm to map the logical address to the physical location of the memory,
wherein the portion of the memory is associated with a wear leveling pool, and
wherein the wear leveling algorithm maps the logical address to a portion of the wear leveling pool based on a randomized parameter; and
writing, by the memory device, the host data to the physical location of the memory.

11. The method of claim 10, wherein the wear leveling algorithm is associated with a periodic wear leveling scheme,
wherein the periodic wear leveling scheme is associated with a wear leveling step event performed after a time threshold is satisfied, and
wherein the randomized parameter is the time threshold.

12. The method of claim 10, wherein the wear leveling algorithm is associated with an activity-based wear leveling scheme,
wherein the activity-based wear leveling scheme is associated with a wear leveling step event performed after an activity threshold is satisfied, and
wherein the randomized parameter is the activity threshold.

13. The method of claim 10, wherein the wear leveling algorithm is associated with multiple wear leveling step events and multiple instances of the randomized parameter, with each wear leveling step event, of the multiple wear leveling step events, being associated with a corresponding instance of the randomized parameter, of the multiple instances of the randomized parameter, and
wherein the multiple instances of the randomized parameter are symmetrically distributed about a mean value of the multiple instances of the randomized parameter.

14. The method of claim 13, wherein the multiple instances of the randomized parameter are symmetrically distributed about the mean value of the multiple instances of the randomized parameter based on one of:
a uniform distribution,
a triangular distribution,
an anti-triangular distribution, or
a Gaussian distribution.

15. The method of claim 10, wherein the wear leveling algorithm is associated with multiple wear leveling step events,
further comprising determining whether to move from a first wear leveling step event, of the multiple wear leveling step events, to a second wear leveling step event, of the multiple wear leveling step events, by comparing a counter to the randomized parameter.

16. The method of claim 15, wherein the counter is associated with one of a quantity of clock cycles associated with a wear leveling step event, of the multiple wear leveling step events, or a quantity of accesses to the portion of the memory associated with the wear leveling step event.

17. The method of claim 10, further comprising determining the randomized parameter by using a pseudo-random vector generator that is based on an identifier associated with the memory device.

18. The method of claim 17, wherein determining the randomized parameter by using the pseudo-random vector generator comprises determining the randomized parameter based on adding a value generated by the pseudo-random vector generator to a minimum value associated with the randomized parameter.

19. A non-transitory computer-readable medium storing a set of instructions, the set of instructions comprising:
one or more instructions that, when executed by one or more processors of a memory device, cause the memory device to:
receive, from a host device, a write command instructing the memory device to write host data to a portion of a memory associated with a logical address;
determine a physical location of the memory associated with the logical address by using a wear leveling algorithm to map the logical address to the physical location of the memory,
wherein the wear leveling algorithm is associated with one of a periodic wear leveling scheme based on a time threshold or an activity-based wear leveling scheme based on an activity threshold, and
wherein the wear leveling algorithm randomizes one of the time threshold or the activity threshold; and
write the host data to the physical location of the memory.

20. The non-transitory computer-readable medium of claim 19, wherein the wear leveling algorithm is associated with multiple wear leveling step events and multiple instances of the one of the time threshold or the activity threshold, with each wear leveling step event, of the multiple wear leveling step events, being associated with a corresponding instance of the one of the time threshold or the activity threshold, of the multiple instances of the one of the time threshold or the activity threshold, and
wherein the multiple instances of the one of the time threshold or the activity threshold are symmetrically distributed about a mean value of the multiple instances of the one of the time threshold or the activity threshold.
